(19) United States
(12) Patent Application Publication
(10) Pub. No.: US 2026/0061791 A1
(43) Pub. Date: Mar. 5, 2026

(54) HITCH PIN LOCK GUARD

(71) Applicant: Gary L. Nelson, Gresham, OR (US)

(72) Inventor: Gary L. Nelson, Gresham, OR (US)

(21) Appl. No.: 18/817,069

(22) Filed: Aug. 27, 2024

(51) Int. Cl. B60D 1/60; B60D 1/06; B60D 1/52; E05B 77/44

(52) U.S. Cl. CPC B60D 1/60; B60D 1/06; B60D 1/52; E05B 77/44

(57) ABSTRACT

Disclosed are a method and device for securely attaching a trailer hitch ball mount assembly to a trailer hitch. In one application, a hitch pin lock guard may be shaped to fit over a trailer hitch pin while the trailer hitch pin is disposed through aligned holes of a trailer hitch and ball mount assembly. In an example, implementation, an exterior of hitch pin lock guard may be tapered so that a cross-sectional of the hitch pin lock guard decreases as the hitch pin lock guard extends away from the trailer hitch.

### FIELD

Embodiments disclosed herein relate to equipment for attachment of trailers to motor vehicles.

### INFORMATION

A trailer hitch ball mount assembly is typically secured to a trailer hitch by inserting the ball mount assembly into the trailer hitch while aligning holes in the trailer hitch with holes in the trailer hitch ball mount assembly. A trailer hitch pin may then be inserted in the aligned holes to secure the trailer hitch ball mount assembly to the trailer hitch. Once the trailer hitch pin is inserted, the trailer hitch pin may be locked in place by a locking pin or Cotter pin, and/or by a lock which may be opened or closed by a key.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may be best understood by reference to the following detailed description if read with the accompanying drawings in which:

FIG. 1A is a depiction of a trailer hitch pin that may be secured by a key lock, according to an embodiment;

FIG. 1B is a view of a trailer hitch ball mount assembly having a trailer hitch pin disposed in holes formed therein, according to an embodiment;

FIG. 2 is a view of an assembly of a trailer hitch pin, key lock and hitch pin lock guard, according to an embodiment;

FIGS. 3 and 4 are views of an assembly of a trailer hitch pin, key lock and hitch pin lock guard implanted to secure a trailer hitch ball mount assembly to a trailer hitch, according to an embodiment;

FIG. 5 is a view of a hitch pin lock guard to be disposed over a portion of a trailer hitch pin that is to extend beyond a trailer hitch, according to an embodiment; and

FIG. 6 is a schematic diagram of views of a hitch pin lock guard to be disposed over a portion of a trailer hitch pin that is to extend beyond a trailer hitch, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

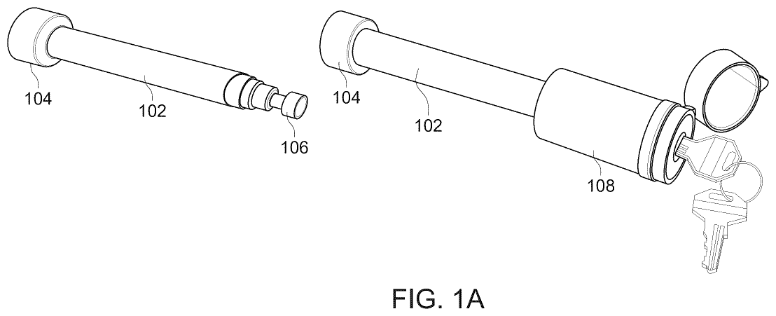

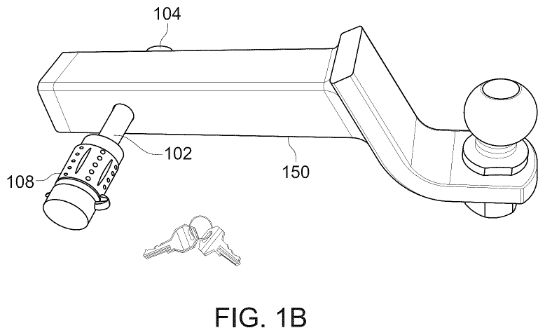

Trailer hitches attached to vehicles are typically of a standard size, and are adapted to receive any trailer hitch ball mount assembly in that standard size. As such, most trailer hitch ball mount assemblies will fit into most commercially available trailer hitches. Since a trailer hitch ball mount assembly may be interchangeable to fit any commercially available trailer hitch, theft of trailer hitch ball mount assemblies and/or trailer attached to the trailer hitch ball mount assembly is fairly common. In one embodiment, to prevent theft of a trailer hitch ball mount assembly, as shown in FIGS. 1A and 1B, a key lock 108 may be provided on one end of a trailer hitch pin 102 pin to prevent removal of trailer hitch pin 102 while trailer hitch pin 102 is disposed through aligned holes of a trailer hitch (not shown) and the trailer hitch ball mount assembly 150. Here, with key lock 108 removed from trailer hitch pin 102 to expose catch 106, trailer hitch pin 102 may be passed through the aligned holes at one end, until catch 106 is exposed at an opposite end and/or stop 104 abuts an exterior of trailer hitch ball mount assembly 150. Key lock 108 may then be secured over catch 106 to secure trailer hitch pin 102 within the aligned holes formed in trailer hitch 150 and formed in trailer hitch ball mount assembly 152.

Nonetheless, key lock 108 at an end of hitch pin 102, by itself, can be easily defeated by a determined thief. For example, such a determined thief may place a pipe over key lock 108 (e.g., so that key lock 108 is inserted into an opening of the pipe at one end), and apply torque/leverage (e.g., by application of force to the pipe at an opposite end) until a portion of trailer hitch pin 102 attached to key lock 108 breaks off. In this particular scenario, an inner surface of the pipe and/or an edge of the opening of the pipe may dig into and/or grip sides of trailer hitch pin 102 and/or key lock 108 to prevent slippage of the pipe while torque/leverage is applied for breaking trailer hitch pin 102.

Briefly, one particular implementation is directed to an apparatus comprising: a hitch pin lock guard to fit over a trailer hitch pin while the trailer hitch pin is disposed through aligned holes of a trailer hitch and ball mount assembly, wherein: an exterior of the hitch pin lock guard is tapered so that a cross-sectional of the hitch pin lock guard decreases as the hitch pin lock guard extends away from the trailer hitch. By covering a trailer hitch pin with a hitch pin lock guard having an exterior that is tapered so that a cross-sectional of the hitch pin lock guard decreases as the hitch pin lock guard extends away from the trailer hitch, gripping the covered hitch pin at an opening of a metal pipe to apply leverage (e.g., for breaking of the hitch pin) may not be possible.

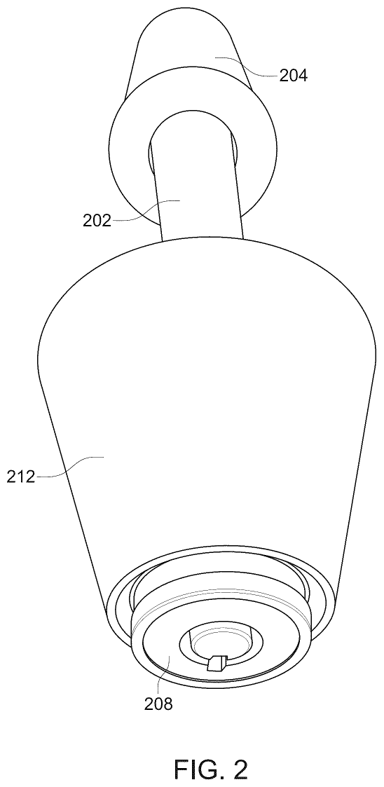

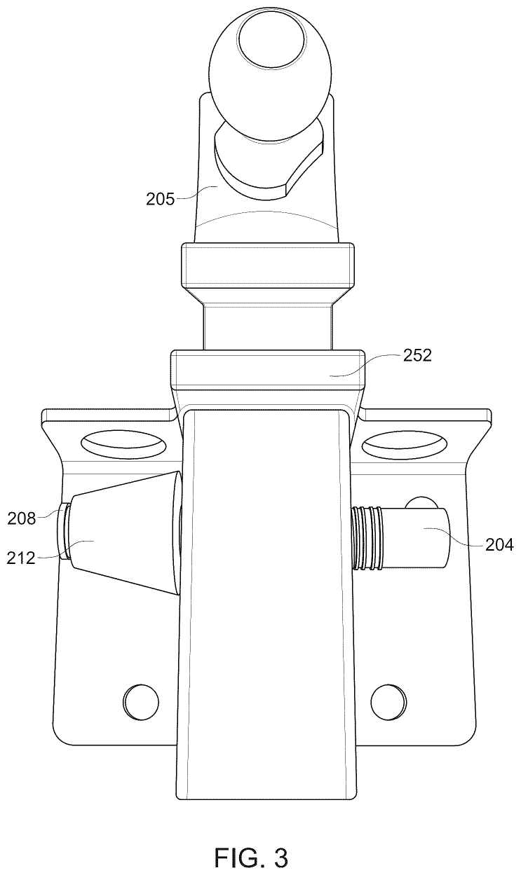

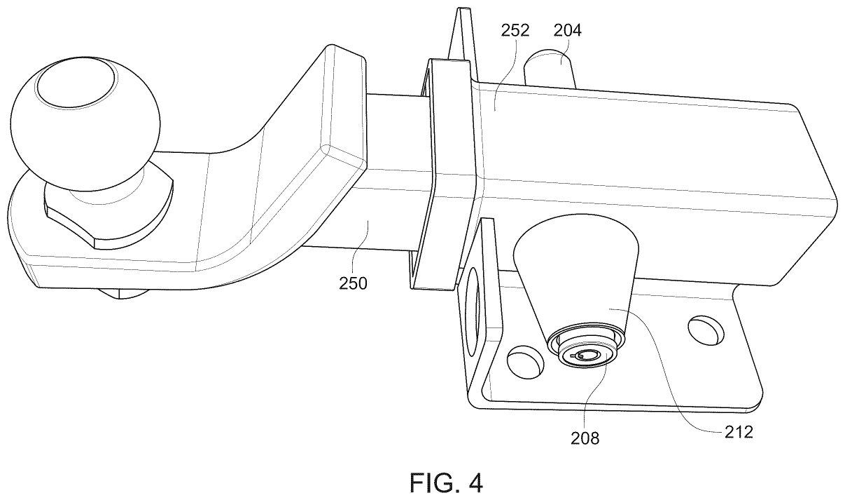

According to an embodiment, FIG. 2 through 5 show features of a hitch pin lock guard 212 for use in connection with a trailer hitch pin 202 to prevent theft of trailer hitch ball mount assemblies (and any trailers connected thereto). Trailer hitch 252 may be mounted to a vehicle (not shown) to pull a trailer, for example. Likewise, trailer hitch ball mount assembly 250 may be connected to a trailer (not shown), to be pulled by a trailer for example. According to an embodiment, trailer hitch ball mount assembly 250 may be inserted into trailer hitch 252 to align holes (not shown) in trailer hitch 252 with holes (not shown) in trailer hitch ball mount assembly 250. Here, trailer hitch pin 202 inserted into the aligned holes may be extended until stop 204 abuts an exterior of trailer hitch 252 and/or a catch (not shown) of trailer hitch pin 202 is extended beyond the exterior of trailer hitch 252. A key lock 208 may then be placed over the catch extending beyond trailer hitch 252 to secure trailer hitch pin 202 in place, and therefore secure trailer hitch 252 to trailer hitch ball mount assembly 250.

Prior to placement of key lock 208 over the catch extending beyond trailer hitch 152, a hitch pin lock guard 212 may be placed over a catch of trailer hitch pin 202 extending beyond trailer hitch 252. Here, hitch pin lock guard 212 may be placed over the catch of trailer hitch pin 202 by passing the catch through opening 220 formed in hitch pin lock guard 212 to extend toward rim 218 an another opening. Trailer hitch pin 202 may be removed from aligned holes of trailer hitch 252 and trailer hitch ball mount assembly 250 by removal of key lock 208. Following removal of key lock 208, hitch pin lock guard 212 may be removed, followed by removal of trailer hitch pin 202 from aligned holes formed in trailer hitch ball mount assembly 250 and trailer hitch 252, enabling trailer hitch ball mount assembly 250 and trailer hitch 252 to be decoupled.

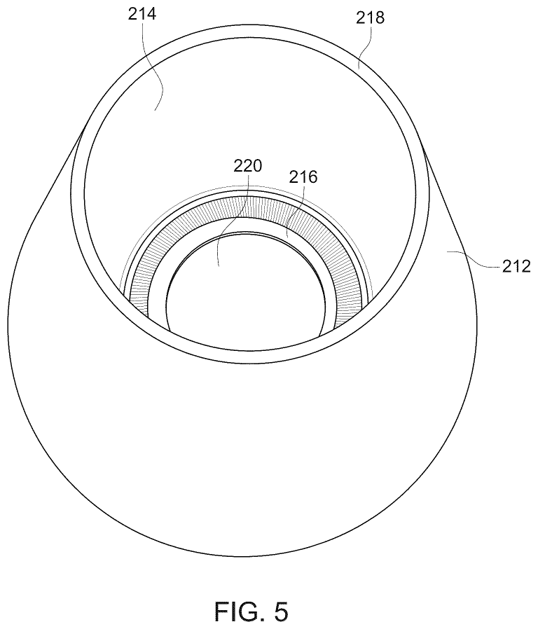

In one particular embodiment, hitch pin lock guard 212 may be shaped so that, while key lock 208 is secured to a catch of trailer hitch pin 202, an outer surface of key lock 208 may be flush with rim 218 of an opening of hitch pin lock guard 212 that is opposite an abutment with trailer hitch 252. As shown in FIG. 5, a surface 216 may be formed on a lip on a bottom portion of an interior 214 of hitch pin lock guard 212. As shown, a depth of interior 214 of hitch pin lock guard 212 may extend from surface 216 to rim 218. In a particular implementation, a such a depth ending from surface 216 to rim 218 may be matched with a length of key lock 208 along an axis of trailer hitch pin 202. For example, while key lock 208 is placed in interior 214 of hitch pin lock guard 212 to engage with a catch of trailer hitch pin 202 (while trailer hitch pin is disposed through aligned holes of trailer hitch 252 and ball mount assembly 250, and stop 204 abuts exterior of trailer hitch 252), key lock 208 may abut surface 216 at one end, and terminate at ridge 218.

According to an embodiment, once trailer hitch pin 202 is inserted through aligned holes of trailer hitch ball mount 250 and trailer hitch 252, and before key lock 208 is placed over an end of trailer hitch pin 202 opposite stop 204, hitch pin lock guard 212 may be placed over the end of trailer hitch pin 102. Key lock 208 may then hold hitch pin lock guard 212 in place over the exposed end of trailer hitch pin 202.

As may be observed from FIGS. 2 through 5, hitch pin lock guard 212 has a conically shaped exterior such that, when secured over hitch pin 202 by key lock 208, hitch pin lock guard 212 is tapered along an axis of hitch pin 202. In particular, when mounted, hitch pin lock guard 212 tapers so that a cross-section of an exterior of hitch pin lock guard 212 along the axis of trailer hitch pin 202 decreases extending along the axis of trailer hitch pin toward a distal end away from trailer hitch 252. Additionally, the exterior of hitch pin lock guard 212 may be finished to have a smooth surface and/or to have a very low coefficient of friction (e.g., a polished chrome finish). As may be observed, a potential thief may not simply slip a metal pipe over trailer hitch pin 102 for applying torque/leverage to break it. Such a metal pipe may be prevented from gripping an exterior surface of hitch pin lock guard 212 (e.g., by preventing an inner surface of the pipe and/or an edge of the opening of the pipe from digging into and/or gripping sides of hitch pin lock guard 212). Without such a grip of the metal pipe on the exterior surface of hitch pin lock guard 212, the metal pipe may slip on the exterior surface of hitch pin lock guard 212 when a thief attempts to apply torque/leverage. n other words, if an opening at one end of such a metal pipe is fitted over hitch pin lock guard 212 (e.g., enclosing trailer hitch pin 202 and/or key lock 208) while a force is applied at an opposite end of the metal pipe, the metal pipe may fail to grip the exterior of hitch pin lock guard 212. This may make application of sufficient torque to break trailer hitch pin 202 by the pipe fitted over hitch pin lock guard 212 virtually impossible.

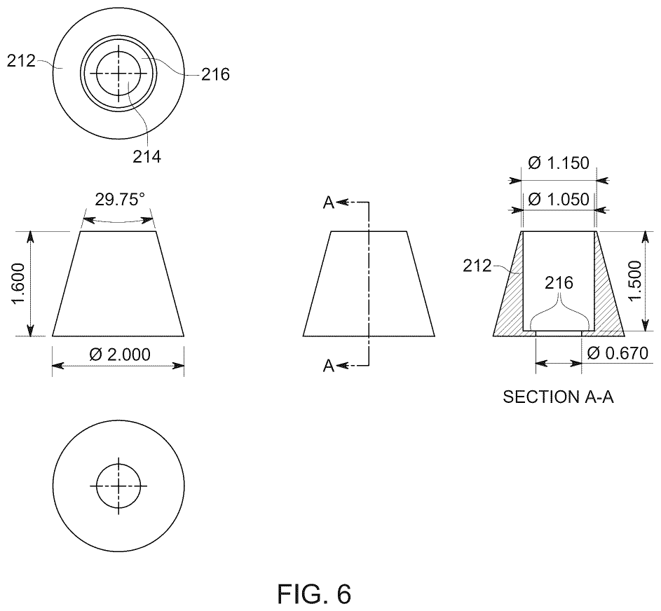

In one embodiment, hitch pin lock guard 212 comprises a conically shaped exterior to be coaxial with the axis of trailer hitch pin 202 as shown in FIG. 2. In a particular implementation, hitch pin lock guard 212 may be formed from a suitable metal such as steel or aluminum, and formed using a casting, lathe or billet fabrication process, for example, followed by suitable coating and/or polishing and exterior surface. A diameter of a circular cross-section of hitch pin lock guard relative 212 relative to the axis of trailer hitch pin 202 may decrease moving away from a trailer hitch exterior toward a distal end where key lock 208 is to receive a key (not shown). In one aspect, as shown in FIGS. 5 and 6, hitch pin lock guard 212 may comprise a first flat end 217 defining a largest area cross-section relative to the axis of trailer hitch pin 202 and a second flat end at rim 218 opposite first flat end 217 defining a smallest area cross-section relative to the axis. In other words, an exterior of metal hitch pin lock guard 212 may be tapered so that a cross-sectional of hitch pin lock guard 212 relative to an axis of trailer hitch pin 102 may decrease from a point of abutment of metal hitch pin lock guard 212 with an exterior of the trailer hitch 252 to a distal end of trailer hitch pin 202.

Key lock 208 may be dimensioned to abut an exterior of trailer hitch 250 while key lock 208 is in a locked position. Hitch pin lock guard 212 may comprise a depth along the axis from the first flat end 217 to the second flat end at rim 218 such that an exterior of key lock 208 is positioned to be flush with rim 218 at an opening at the second flat end.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled. ” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second'” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
inserting a ball mount assembly into a trailer hitch while aligning holes of the ball mount assembly and the trailer hitch;
inserting a hitch pin through the aligned holes;
disposing a hitch pin lock guard over an exposed end of the hitch pin, the hitch pin lock guard being tapered to decrease a cross-section relative to an axis of the hitch pin extending to a distal end away from the trailer hitch; and
positioning a lock on the exposed end of the hitch pin to secure the hitch pin lock guard in place.

2. The method of claim 1, wherein the hitch pin lock guard comprises a conically shaped exterior to be coaxial with the axis of the hitch pin, a diameter of a circular cross-section of the hitch pin lock guard relative to the axis to decrease moving away from the trailer hitch.

3. The method of claim 1, wherein an exterior of the hitch pin lock guard comprises a chrome finish.

4. The method of claim 1, wherein an exterior of the hitch pin lock guard is polished chrome.

5. The method of claim 1, wherein:
the hitch pin lock guard comprises a first flat end defining a largest area cross-section relative to the axis of the hitch pin and a second flat end opposite the first flat end defining a smallest area cross-section relative to the axis.

6. The method of claim 5, wherein:
the lock comprises a key lock; and
the hitch pin is adapted to receive the key lock to abut an exterior of the ball mount assembly while the key lock is in a locked position.

7. The method of claim 6, wherein:
the hitch pin lock guard comprises a depth along the axis from the first flat end to the second flat end such that an exterior of the key lock is positioned to be flush with a rim of the hitch pin lock guard at an opening at the second flat end.

8. An apparatus comprising:
a hitch pin lock guard to fit over a hitch pin while the hitch pin is through aligned holes of a trailer hitch and ball mount assembly, wherein:
an exterior of the hitch pin lock guard is tapered so that a cross-sectional of the hitch pin lock guard relative to an axis of the hitch pin decreases from a point of abutment of the hitch pin lock guard with an exterior of the trailer hitch to a distal end of the hitch pin.

9. The apparatus of claim 8, wherein an exterior of the hitch pin lock guard is polished chrome.

10. The apparatus of claim 8, wherein:
the hitch pin lock guard comprises a first flat end defining a largest area cross-section relative to the axis of the hitch pin and a second flat end opposite the first flat end defining a smallest area cross-section relative to the axis of the hitch pin.

11. The apparatus of claim 10, wherein:
the hitch pin is adapted to receive a key lock to abut an exterior of the ball mount assembly while the key lock is in a locked position.

12. The apparatus of claim 11, wherein:
the hitch pin lock guard comprises a depth along the axis of the hitch pin from the first flat end to the second flat end such that an exterior of the key lock is positioned to be flush with a rim of the hitch pin lock guard at an opening at the second flat end.

13. The apparatus of claim 8, wherein the hitch pin lock guard comprises a conically shaped exterior to be coaxial with the axis of the hitch pin, a diameter of a circular cross-section of the hitch pin lock guard relative to the axis of the hitch pin to decrease moving away from the trailer hitch.
